(19) United States
(12) Patent Application Publication
(10) Pub. No.: US 2025/0139218 A1
(43) Pub. Date: May 1, 2025

(54) CRYPTOGRAPHICALLY COMMUNICABLE TOKEN FOR MECHANICAL COUPLING AND COMMUNICATION WITH HAND-HELD TOOLS

(71) Applicant: WÜRTH INTERNATIONAL AG, Chur (CH)

(72) Inventors: Heiko ROSSKAMP, Adelberg (DE); Adrien MARQUETTE, Schwäbisch Hall (DE); Louisa ASCHOFF, Neuenstein (DE)

(21) Appl. No.: 18/687,766

(22) PCT Filed: Jul. 28, 2022
(86) PCT No.: PCT/EP2022/071152

§ 371 Date: Feb. 28, 2024

(30) Foreign Application Priority Data
Aug. 31, 2021 (EP) 21290053.4

(51) Int. Cl. G06F 21/34; B25F 5/00

(52) U.S. Cl. CPC G06F 21/34; B25F 5/00

(57) ABSTRACT

Token for craftsman devices of a craftsman equipment, the token comprising a processor which is configured for control-related interaction with different craftsman devices of the craftsman equipment, a cryptographic unit which is configured for cryptographic communication of the token, and a mechanical coupling device, which is configured for mechanical coupling with different craftsman devices of the craftsman equipment, wherein the token is configured to exchange data with the said craftsman device by means of the processor when the mechanical coupling device is mechanically coupled with a craftsman device, and in particular to control the said craftsman device.

### CROSS-REFERENCE TO RELATED APPLICATION

This application is a national stage application, filed under 35 U.S.C. § 371, of International Patent Application No. PCT/EP2022/071152, filed on Jul. 28, 2022, claiming priority of the European patent application EP 21 290 053.4 filed on Aug. 31, 2021, all of them being incorporated by reference herein in its entirety.

### FIELD OF INVENTION

The invention relates to a token for craftsman devices of a craftsman equipment, a token arrangement, a craftsman equipment, and a method for operating craftsman devices of a craftsman equipment by means of a token.

### ART BACKGROUND

Conventional hand-held tools are controlled directly by a user. For example, a drill is controlled by a user inserting a suitable drill bit into the drill and then pressing an actuation button on the drill. If a user without specialist knowledge performs a delicate manual task using such a hand-held tool, this can lead to incorrect operation, an undesirable result and a risk to operational safety.

DE 10258900 A1 discloses a cordless screwdriver for tightening screw components, with a screwdriver motor which is supplied with electrical voltage from a self-sufficient power supply arranged on the cordless screwdriver, at least three measuring devices which are provided for monitoring screwdriving parameters during the screwdriving process, namely a torque sensor, with which the tightening torque generated by the screwdriver motor can be measured, a rotation angle sensor, with which the current screw-in angle can be measured starting from a predetermined measuring position, and a current sensor, with which the drive current of the screwdriver motor can be measured. Furthermore, monitoring electronics are provided which switch off the screwdriver motor if the tightening torque, the screw-in angle and the drive current are all within a predetermined, assigned target parameter window.

Conventional hand-held tools reach their limits, especially when it comes to difficult or unusual processing tasks using a hand-held tool.

### SUMMARY OF THE INVENTION

There is a need of the present invention to enable operation of a hand-held tool in a simple, safe and error-resistant manner.

This need is met by the objects with the features according to the independent patent claims. Further embodiments are shown in the dependent claims.

According to one embodiment of the present invention, a token for craftsman devices (in particular for controlling craftsman devices) of a hand-held equipment is created, the token having a processor which is configured for control-related interaction with different craftsman devices of the hand-held equipment, a cryptographic unit which is configured for cryptographic communication of the token, and a mechanical coupling device which is configured for mechanical coupling with different craftsman devices of the craftsman equipment, the token being configured to exchange data with the said craftsman device by means of the processor when the mechanical coupling device is mechanically coupled with a craftsman device, and in particular to control the said craftsman device.

According to a further embodiment of the present invention, there is provided a token arrangement comprising a plurality of tokens having the features described above, wherein different ones of the tokens have different degrees of functionality.

According to a further embodiment of the invention, a craftsman equipment is provided which has a token with the features described above and a plurality of craftsman devices, at least some of which have a mechanical receiving device for mechanical coupling to the mechanical coupling device of the token, the token being configured for user-related data exchange with, in particular control of, that one of the craftsman devices to whose mechanical receiving device the mechanical coupling device of the token is mechanically coupled.

According to a further embodiment of the invention, a method is provided for operating craftsman devices of a handheld equipment by means of a token having the features described above, the method comprising mechanically coupling the mechanical coupling means of the token to a mechanical receiving device of a selected one of the craftsman devices, and, after mechanical coupling has taken place, exchanging data with said craftsman device, and in particular controlling the craftsman device, by means of the processor.

In the context of the present application, a “token” can be understood in particular as a recognition token that can form a functional coupling between the token and a craftsman device. Such an identification token can be used in a coupled system, which can comprise the token, a craftsman device mechanically coupled thereto and optionally one or more other devices or nodes. In particular, a token may be a hardware component for identifying and/or authenticating a user to whom the token may be assigned. A token may be an electronic token and may, for example, provide a processor-related control, monitoring and/or communication function.

In the context of the present application, a “craftsman device” can be understood in particular as a device that is used by a craftsman during a manual activity. In particular, this may be an electric hand-held tool (such as a cordless screwdriver), a (particularly non-electric) tool (for example a hammer, pliers, file, screwdriver or drill) or a tool set with several tools or tool elements (for example a drill box with drills or a bit box with bits), a storage system (for example, a toolbox), consumables (for example, bolt anchors or a box of screws), and/or a vehicle (for example, a motor vehicle in which a craftsman can transport his equipment to a work site, a forklift or a tool cart) and/or other craftsman equipment (for example, a ladder). A craftsman device can also be a battery pack or an adapter between a battery pack and a processing device (for example, a drill module of a drill). For example, a token can be inserted into such a battery pack or such an adapter.

In the context of the present application, a “hand-held tool” can be understood in particular as a portable device that can be operated and carried manually by a user and with which a manual task can be performed, for example working on a surface. Advantageously, the hand-held tool can be an electric hand-held tool that can be operated by means of an electrically generated driving force. Such an electric hand-held tool can be controlled by means of electrical control signals—in particular provided by means of a token. In particular, a hole can be drilled in a substrate and/or a driving force in the form of a longitudinal force and/or a torque can be applied to a fastening element to be set in a substrate by means of a hand-held tool and by applying a driving force in the form of a longitudinal force and/or a torque. For example, the hand-held tool can be configured to rotate a processing device and thus a drill and/or a fastening element. Examples of electric or motorized hand-held tools are a cordless screwdriver, a cordless drill driver, a rotary screwdriver, a pulse screwdriver, a ratchet screwdriver, a drill, an impact screwdriver (in particular a cordless impact screwdriver) and a hammer drill.

In the context of the present application, a “craftsman equipment” may be understood in particular as a set comprising a plurality of craftsman devices which a craftsman uses in combination to perform craftsman's tasks. For example, a craftsman equipment may include at least ten, in particular at least one hundred, craftsman devices.

In the context of this application, the term “processor” can be understood in particular to mean an electronic entity which can contain an arithmetic unit and/or a control unit and/or can be configured for data processing. In particular, such a processor can have a controlling effect on a craftsman device mechanically coupled to the token and thereby set an operation or an operating mode of the craftsman device (in particular a hand-held tool). In particular, the processor can control the setting of the operation or mode of operation of the craftsman device or a part thereof, in particular based on a user profile of a user of the token. The control logic between the token and the craftsman device and/or between the token and another node (in particular another node or a central control device) can, for example, take place according to a master-slave architecture or according to a peer-to-peer architecture. The processor of the token can alternatively or additionally take over other functions, for example evaluating sensor signals from a sensor of the token, controlling communication with another node via a communication network, etc. A processor can, for example, be realized by a processor component, a plurality of processor components or a part of a processor component.

In the context of the present application, a “cryptographic unit” may in particular be understood as an entity (in particular a separate hardware component or a part of another hardware component, for example a processor) which accomplishes encrypted communication between the token and a node communicably coupled thereto (for example a craftsman device mechanically coupled to the token and/or another node of a communication network in which the token is communicably coupled). For example, a cryptographic unit may be a crypto-engine of a computer chip. In particular, a cryptographic unit can encrypt and/or decrypt (especially electrical or electromagnetic) signals. A cryptographic communication of a token with one or more craftsman devices and/or other nodes may, for example, be based on the use of keys and/or encryption algorithms. The cryptographic unit may therefore be used for encrypted communication of the token with a craftsman device mechanically coupled thereto and/or with another entity via a communication network, such as the public Internet. This encrypted communication increases data security.

In the context of the present application, a “mechanical coupling device” can be understood in particular as a physical structure or a form factor of the token which can be coupled, for example in a form-fit and/or frictionally engaged manner, to a corresponding physical structure of a craftsman device in order to thereby form a mechanical connection, in particular a temporary and well-defined mechanical connection, between the token and the craftsman device. For example, the token can be inserted into a correspondingly shaped receiving opening of the craftsman device in order to mechanically couple the token and the craftsman device. In this case, the mechanical coupling device can be configured to simultaneously establish a communicable coupling between the token and the craftsman device simply by forming a mechanical coupling with a hand-held tool.

In the context of the present application, “different degrees of functionality” of tokens of a token arrangement can be understood to mean in particular that different tokens of the token arrangement all enable a certain type of function (for example a processor function, a sensor function and/or a communication function), but with different characteristics, intensity and/or diversity. For example, as far as a sensor functionality is concerned, a token with a lower degree of functionality may have a user identification sensor, while a token with a higher degree of functionality may also have a GPS sensor.

According to an exemplary embodiment of the invention, a universally applicable token is provided for selectively communicating with and optionally controlling a respective one of a plurality of craftsman devices of a craftsman equipment, wherein a communication link is formed between the token and said craftsman device by mechanically coupling the token to a specific craftsman device, which enables data exchange or control. This means that a user can assign the token to the craftsman device to be controlled simply by carrying out the intuitive process of mechanically coupling the token with a selected craftsman device (for example by inserting the token into an opening in the craftsman device); no further user activity is required to assign the token to the craftsman device and couple it with the craftsman device so that it can communicate or be controlled. Preferably encrypted and therefore secure communication between the token and the mechanically coupled craftsman device enables reliable data communication or control once the mechanical coupling has been formed. Operational reliability can also be increased by establishing a specific mechanical connection between the token and the craftsman device in order to form a (particularly unidirectional or bidirectional) data exchange link or control link between the token and the craftsman device. An owner of a (preferably user-related) token can thus precisely define which craftsman device is to exchange data with the token or is to be controlled.

Advantageously, a token as a universal electronic key can optionally be inserted into any craftsman device (for example a drill, a ladder, a storage rack or a forklift) of a craftsman device (for example a machine park) in order to carry out access and/or operation control of this craftsman device or a specific data exchange with this craftsman device. By means of a token according to an exemplary embodiment of the Invention, it is also possible to retrofit a conventional craftsman device to provide Internet connectivity.

Additional exemplary embodiments of the token, the token arrangement, the craftsman equipment and the method are described below.

According to an exemplary embodiment, the token can be configured as a plug-in element for insertion into a receiving opening of a craftsman device. The process of inserting the token, which is configured as a plug-in element, into the receiving opening of a selected hand-held tool then intuitively triggers the formation of a controllable connection between the token and the hand-held tool. For example, a geometry of the token configured as a plug-in element can be inverse to a geometry of the receiving opening in the hand-held tool. A connection between the token and the craftsman device can then be formed according to a lock-and-key principle in order to establish a communicable coupling. By inserting a token into an opening in a craftsman device, the token can be protected from environmental influences during operation of the craftsman device. For example, a token can be protected from drilling dust released during operation of the drilling machine in a receiving opening of a craftsman device configured as a drilling machine.

According to an exemplary embodiment example, the token can be configured as a disk, in particular as a circular disk, with a diameter in a range from 1 cm to 10 cm, in particular in a range from 2 cm to 5 cm. It is also possible for the token to be configured as a cuboid (in particular a flat cuboid) with an edge length in the range from 1 cm to 10 cm, in particular in the range from 2 cm to 5 cm. A token formed as a small disk can be conveniently carried by a user and allows the formation of a mechanical coupling with a craftsman device in a space-saving manner. In addition, the formation of the token as a circular disk with the aforementioned dimensions allows the implementation of a sensor identifying a user of the token, in particular a fingerprint sensor, on a surface of the token. For self-identification, which may be a prerequisite for the formation of a controllable coupling between the token and the craftsman device, it may be sufficient for a user to identify himself by placing a finger on the fingerprint sensor. After successful identification, the authorization of the identified user to control the craftsman device coupled with the token can be checked in the token. If the check is successful, control can be started; if the check is unsuccessful, control can be stopped.

According to an exemplary embodiment, the mechanical coupling device can be configured to be able to remove the token from the craftsman device again after mechanical coupling. In this way, a user who wishes to use a craftsman device can mechanically couple a token assigned to him to the craftsman device and remove the token from the craftsman device again after use has ended. The craftsman device can be configured to allow control of the craftsman device by the token or even use of the craftsman device only during the existence of a mechanical coupling with a token.

According to an exemplary embodiment, the mechanical coupling device can have an electromechanical interface, in particular an electromechanical interface that is universal for different craftsman devices. An electromechanical interface can be understood here to mean that the formation of a mechanical connection between the mechanical coupling device of the token and a corresponding mechanical receiving or connecting device of the hand-held tool simultaneously leads to the formation of an electrical coupling between the token and the hand-held tool. A positive coupling of the token and the craftsman device, for example, can then also enable the transmission of an electrical control signal from an electrical contact of the token to an electrical contact of the craftsman device. This type of craftsman equipment is particularly robust in operation.

According to an exemplary embodiment example, the token can be configured to form a communication connection, in particular a contactless or contact-based communication connection, with the craftsman device when the mechanical coupling device is mechanically coupled to a craftsman device. With reference to the embodiment example described above concerning an electromechanical coupling between token and craftsman device, contact-based electrical communication between token and craftsman device can preferably only be enabled when the mechanical connection is formed. This allows a user to retain control sovereignty through an intuitive connection process. Alternatively, a contactless communication link between the token and the craftsman device can only be established by forming a mechanical coupling between the token and the craftsman device. For example, a wireless transponder (e.g. an RFID tag) of the token can only be brought into a readable distance of a transponder reader (e.g. an RFID reader) of the craftsman device by inserting the token into the craftsman device. This can be achieved, for example, by using a short-range communication protocol (e.g. NFC, near field communication) for wireless communication between the token and the craftsman's device.

According to an exemplary embodiment, the token can have at least one sensor, in particular selected from a group consisting of a user identification sensor, a gyro sensor, a location sensor, a temperature sensor, a sound pressure sensor, a vibration sensor, an acceleration sensor, a position sensor, a current sensor, a voltage sensor, and a sensor for measuring an electric and/or magnetic field. The token can be particularly advantageously equipped with a user identification sensor, for example a fingerprint sensor or a face recognition sensor. If configured as a fingerprint sensor, a user only needs to place a finger on the token to identify themselves. After forming a mechanical coupling of the token with a craftsman device, the sensor-detected identity of the user can then be used to determine whether the user is authorized or entitled to operate the craftsman device and, if so, whether the use of the craftsman device by the user is subject to certain restrictions or special features. The described user-related setting of the operation of the craftsman device can advantageously be carried out on the basis of a user profile of the sensor-identified user, which can, for example, be stored in the token or can be retrieved from the token via a communication network. Alternatively or additionally, the token can have a gyro sensor. Such a gyro sensor can be an acceleration sensor that reacts to accelerations, rotational movements or changes in position. Such information can be used, for example, to control the craftsman device. For example, if a craftsman device including a token falls down, the impact can be detected by a gyro sensor and the craftsman device can be switched off. Alternatively or additionally, the at least one sensor of the token can have a location sensor, for example a GPS sensor. In this way, the token can determine the current location of the token and a craftsman device mechanically coupled to it. For example, operation of the craftsman device can be restricted to a specific location or area (e.g. a specific construction site). If the location sensor detects that the token and the hand-held tool are outside such an authorized area, the token can control the hand-held tool in such a way that its operation in an unauthorized area is prevented. This improves the protection of the craftsman device against misuse. A temperature sensor can also be implemented in the token. For example, the use of a craftsman device coupled with a token can be prevented by the control system if a detected temperature is outside an authorized operating range of the craftsman device. For example, if a chemical dowel is to be set using a hand-held tool, but the ambient temperature is outside an approved temperature range for setting the chemical dowel, the setting of the chemical dowel can be prevented.

According to an exemplary embodiment, the token may comprise at least one communication antenna, in particular selected from a group consisting of a GPS (Global Positioning System) antenna, a BLE (Bluetooth Low Energy) antenna, an ultra-wideband (UWB) antenna, a Bluetooth antenna, a WLAN (Wireless Local Area Network) antenna, and a narrowband Internet of Things (IoT) antenna. By means of such a communication antenna, wireless communication of the token via a communication network is possible, which enables further refined control of a craftsman device mechanically coupled to the token using data transmitted via the communication network.

According to an exemplary embodiment, the processor may be selected from a group consisting of a Bluetooth processor, a Narrowband Internet of Things (IoT) processor, an LTE (Long Term Evolution) processor, a 5G processor and an NFC (Near Field Communication) processor. Alternatively or additionally, the processor can operate according to another existing or future communication protocol.

According to an exemplary embodiment, the token can have a power supply device. For example, a (e.g. replaceable) battery or a (particularly rechargeable) battery can be integrated into the token. Equipping the token with a power supply device has the advantage that the token has a self-sufficient power supply independent of other entities. For example, the token can then communicate with other nodes via a communication network even when it is not coupled to a craftsman device. Alternatively, the token can be free of such a power supply device and be powered by energy provided by a craftsman device. For example, when the mechanical coupling between the token and the craftsman device is formed, an inductive or electrically conductive coupling can be formed between the token and the craftsman device, via which the token can be supplied with electrical energy from a battery or a mains connection of the craftsman device.

According to an exemplary embodiment, the token can have a communication device that is configured to communicate by means of a communication network. In particular, the token can be configured for cryptographic communication using the cryptographic unit. For example, communication can take place via the public Internet, via an intranet and/or via a mobile network. Such a communication device may include, for example, a transmitting and/or receiving antenna and an associated processor resource which enable, for example, wireless communication in accordance with a communication protocol of the communication network with one or more other nodes of such a communication network. In this way, the token can communicate unidirectionally or bidirectionally with one or more other nodes beyond the control of a craftsman device mechanically coupled to it, for example to download (download) and/or upload (upload) information. For example, a download of information from a communicatively coupled node to the token may include a download of a user profile or a flow control processing task to be performed by a user using a craftsman device mechanically coupled to the token. For example, an upload of information from the token to a communicatively coupled node can include an upload of tracking data that enables the tracking of an operation of the token and/or a craftsman device coupled to it for documentation and/or quality monitoring purposes. Operating data documenting the execution of a processing task by a hand-held tool coupled with the token can also be uploaded from the token to a communicatively coupled node.

According to an exemplary embodiment, the token can be configured to communicate by means of the communication device with at least one communicably coupled node of the communication network, which is selected from a group consisting of another token, a portable user terminal with an app stored thereon (which can be configured to communicate with a token), a central control device (for example for centrally managing or controlling craftsman devices of a craftsman equipment), and a reordering device for reordering consumables for operating a craftsman device. According to one embodiment, several tokens can communicate with each other. For example, a first token can be mechanically coupled to a first hand-held tool (for example, a hand-held tool such as a hammer drill) and a second token can be mechanically coupled to a second hand-held tool (for example, protective work equipment such as safety goggles). If, for example, the use of protective work equipment is prescribed for the operation of the hand-held tool, the commissioning of the hand-held tool can be made dependent on communication between the two associated tokens documenting that the user of the hand-held tool associated with the first token is wearing the protective work equipment associated with the second token. However, it is also possible for a user to control a hand-held tool from a portable user terminal (e.g. a cell phone) equipped with appropriate software and thus from a remote location. For this purpose, the user terminal and the token can communicate with each other via a communication network. If necessary, the token can also use resources of the user terminal device, for example a camera resource, to control the craftsman device. Furthermore, it is possible for a central control device to control a large number of decentralized craftsman devices, for example in the sense of user profiles, which enable individual users of the decentralized craftsman devices to use certain craftsman devices in a user-specific manner. In other words, user profiles of users can be stored on a central control device. If a token mechanically coupled to a handheld tool wishes to allow use of the handheld tool by a user identified by the token, the token can gain access to the user profile of the associated user by communicating with the central control device and only allow use of the handheld tool by that user if the use of the handheld tool by the identified user is in accordance with the user profile. For example, the use of a chainsaw can be made dependent on a user's corresponding qualification or instruction, which is reflected in the user profile. In addition, it may also be possible for a token mechanically coupled to a craftsman device to recognize a need to reorder consumables and transmit it to a communicatively coupled reordering device. For example, such a token can be mechanically coupled to a container holding consumables and can recognize the successive removal of consumables from this container (for example by sensors).

For example, when a remaining stock of consumables falls below a predefined threshold value, a reorder can then be triggered by the token, namely by direct or indirect communication between the token and the reordering device.

According to an exemplary embodiment, the token can be configured to download a data set from a communicatively coupled node of the communication network by means of the communication device, in particular a data set defining an operating sequence of the hand-held tool and/or a data set defining a user profile of a user of the token. A communicable coupling can, for example, be wired (for example, electrically via at least one electrical line or optically via an optical fiber) or wireless (for example, by transmitting electromagnetic radiation, such as visible light, infrared light or high-frequency radiation). The aforementioned and/or other data can be stored at a central location of the communication network, for example at a central control device for controlling or managing a plurality of craftsman devices, and thus with an overall efficient use of resources. If necessary, a decentralized token—for example, mechanically coupled to a craftsman device—can retrieve the data from the central control device or another node via the communication network. By retrieving a data set defining an operating sequence of the craftsman device, the token can receive control information to control the craftsman device accordingly to perform said operating sequence and subsequently control the craftsman device accordingly.

For example, setting a fastener (e.g. a screw) in a substrate may require the application of a certain torque, the magnitude of which the token can retrieve via the communication network. It is also possible that a user identified by means of the token is subject to certain restrictions regarding the use of a handheld tool mechanically coupled to the token, so that the use of a handheld tool by a particular user is only permitted by the token in accordance with a corresponding user profile that the token can download via the communication network.

According to an exemplary embodiment, the token can be configured to upload a data set to a communicatively coupled node of the communication network by means of the communication device, in particular a data set containing operating results and/or operating parameters of an operation of the hand-held tool. For example, a processing task (e.g. setting a fastening element in a substrate) performed by a craftsman device can be documented in the form of a data record and transmitted as operating results to a node of the communication network (e.g. a central management or control device). This allows subsequent tracking for documentation and/or quality assurance purposes. For example, the actual torque applied by a cordless screwdriver when screwing in a screw can be transmitted as an operating parameter in connection with the processing of a machining task.

According to an exemplary embodiment example, the processor can be configured to control the operation of the craftsman device coupled with the token in accordance with a user profile, in particular in accordance with a user authorization profile, of the user of the token. In the user profile, usage authorizations, usage prohibitions and/or usage restrictions can be regulated for a specific user with regard to specific craftsman devices, in particular with regard to specific electrical hand-held tools, tools and/or consumables.

According to an exemplary embodiment, the token can have a memory device in which the user profile, in particular the user authorization profile, is stored. Such a storage device may, for example, be an electronic memory in the form of a semiconductor memory chip that forms part of the token. With local storage of a user profile relating to a user assigned to the token and/or of control data for controlling craftsman devices for processing specific processing tasks, the effort involved in transmitting data between tokens and nodes coupled to them in a communicable manner can be kept to a minimum.

According to an exemplary embodiment, the processor can be configured to enable operation of the craftsman device coupled with the token only if a user identification carried out in advance by means of the token has led to the result that an identifying user is authorized to operate the craftsman device. By using the token to check whether a user identified (for example via a user identification sensor such as a fingerprint sensor) is authorized and/or able to use the hand-held tool before commissioning a hand-held tool, and by making the release for use of the hand-held tool by this user dependent on compatibility between the desired use of the hand-held tool and the user profile of the user, the operational safety during operation of the hand-held tool can be improved.

According to an exemplary embodiment, the tokens of different degrees of functionality may have sensors of different degrees of functionality. For example, a token with a lower degree of functionality may have a smaller number of sensors (for example, only a user identification sensor) than a token with a higher degree of functionality (which, for example, has a location sensor in addition to a user identification sensor). It is also possible to implement a sensor in a token with a higher degree of functionality (for example, a location determination sensor that also enables a spatial orientation to be determined) that provides a further additional function compared to a sensor (for example, a location determination sensor without sensory detection of a spatial orientation) in a token with a lower degree of functionality.

According to an exemplary embodiment, the tokens of different degrees of functionality may have processors of different degrees of functionality. For example, a token with a higher degree of functionality may have a processor with a higher performance (for example with a higher clock frequency and/or with a higher number of CPU cores) than a token with a lower degree of functionality. It is also possible to provide a further processor, for example a radio chip, in addition to a basic processor (for example a microprocessor) for a token with a higher degree of functionality.

According to an exemplary embodiment, the tokens of different degrees of functionality may have communication antennas of different degrees of functionality. For example, a token with a lower degree of functionality may have a smaller number of communication antennas (for example, only one communication antenna) than a token with a higher degree of functionality (which, for example, in addition to a first communication antenna for communication according to a first communication protocol (for example, Bluetooth), enables a second communication antenna for communication according to a second communication protocol (for example, WLAN).

According to an exemplary embodiment, the craftsman devices may comprise at least two different elements from a group consisting of the following elements: From an electric or motorized hand-held tool (for example a drill), a tool (for example a drill) or a tool set (for example a drill set in a drill box), a storage system (for example a case or a tool box), a consumable (for example a bolt anchor or a box of dowels), and a vehicle (for example a passenger car or a forklift). According to a preferred embodiment example, several hand-held tools, several tools and/or tool sets, several storage systems, several consumables and several vehicles can be managed as craftsman equipment. According to a configuration with a plurality of tokens and a plurality of craftsman devices of different types, in which a respective token can be mechanically coupled with any craftsman device and thus brought into operative connection, a complex and arbitrarily scalable modular system is created that enables efficient and reliable management of even a large number of craftsman devices. By allowing communication between a respective token and a craftsman device mechanically coupled to it and/or communication between different tokens and/or at least one other node in an associated communication network, even a huge, diversified and spatially decentralized system of craftsman devices (e.g. a machine park or craftsman equipment of a company) can be managed in an error-resistant, reliable and misuse-proof manner.

According to an exemplary embodiment, at least one of the hand-held tools can be configured as a motorized or electric hand-held tool from a group consisting of a drill, a cordless screwdriver, a cordless drill driver, a rotary screwdriver, a pulse screwdriver, a ratchet screwdriver, an impact wrench, in particular a cordless impact wrench, a hammer drill, a corded hand-held tool and a compressed air-operated hand-held tool.

### BRIEF DESCRIPTION OF THE DRAWINGS

In the following, exemplary embodiments of the present invention are described in detail with reference to the following figures.

FIG. 1 shows a craftsman equipment with craftsman devices and tokens according to an exemplary embodiment of the invention, which are coupled in a communication network with additional communicable nodes.

FIG. 2 shows a token with an associated storage and recharging device according to an exemplary embodiment of the invention.

FIG. 3 shows a token according to an exemplary embodiment of the invention.

FIG. 4 shows components of a craftsman equipment according to another exemplary embodiment of the invention.

FIG. 5 shows a craftsman equipment with craftsman devices and a token according to an exemplary embodiment of the invention, which are coupled in a communication network.

### DETAILED DESCRIPTION

Identical or similar components in different figures are marked with the same reference numbers.

Before exemplary embodiments of the invention are described with reference to the figures, some general aspects of embodiments of the invention will be explained.

According to an exemplary embodiment, a token can be used for use with a craftsman device (for example, a machine tool).

For example, the token can be provided with a combined electrical and mechanical structure. More precisely, different tokens of a token arrangement can have a common basic electrical and/or mechanical structure, but can also differ in terms of a variable additional electrical and/or mechanical structure. As fixed constituents, different tokens of a token arrangement can have a processor (which can, for example, also perform post-processing and/or data compression tasks), a communication device, and a cryptographic unit (in particular a decrypter), A variable proportion of different tokens of a token arrangement may, for example, have differences with regard to at least one transmit/receive unit, at least one antenna and/or at least one sensor.receiving unit, at least one antenna and/or at least one sensor. A respective token may be formed as an object that may have a packaging component, one or more slots, compatibility with a battery, and/or a conductor adapter. It is also possible for a token to be supplied with electrical power from an external source. According to an exemplary embodiment, a token system can perform (in particular indirect) control of a craftsman device using an authorization concept, in particular using a personalized authorization concept.

Tokens in a token arrangement can have different degrees of functionality and can therefore be assigned to different generations. For example, a token with a first level of functionality can be equipped with limited sensors (e.g. only a temperature sensor and a vibration sensor) in terms of processing and communication as a BLE-capable token. Such a token can be used, for example, to download data sheets from a central node of a communication network. The execution of a processing task using a craftsman device assigned to a token can be made dependent on a current ambient temperature, for example. For example, the setting of a chemical dowel can only be permitted if a minimum processing temperature is ensured. A second-generation token can, for example, be configured as an ultra-wideband token in terms of processing or communication, which can also be equipped with a gyro sensor. For example, such a gyro sensor can detect when a hand-held tool (such as a drill) falls to the ground and can then automatically switch off the hand-held tool. A third-generation token can also be equipped with NB IoT (Narrow Band Internet of Things) functionality and a GPS sensor. A third-generation token can therefore be able to determine the location of the token and a mechanically coupled craftsman device and only grant permission to operate the craftsman device if the determined location is approved for the intended operation of the craftsman device. For example, the commissioning of an excavator can only be approved if the excavator is located on a specific construction site. This provides protection against misuse.

According to an exemplary embodiment of the invention, a token forms a basic unit of a system for the controlled operation of craftsman devices. Such a token can have a fixed component (in particular with microcontroller, decrypter), which can be contained in each token of a token arrangement. Furthermore, each token of a token arrangement can enable an electromechanical connection to craftsman devices (in particular, provide one or more electrical contacts for electrical coupling with a craftsman device). In addition, tokens of a token arrangement may have a variable portion, which may be different for different tokens. Such a variable portion may include equipping a token with one or more sensors (for example, fingerprint sensor, gyroscope, GPS sensor, UWB sensor, temperature sensor), at least one radio chip (for example, configured according to Bluetooth Low Energy, Bluetooth, NB-IoT, LTE Cat. M, 5G, NFC) and/or at least one antenna (for example configured according to 2.5 GPS, BLE, UWB, NB-IoT). Optionally, a token can be equipped with its own power supply, for example a battery or rechargeable battery.

One or more tokens with the described properties can form part of a system of craftsman equipment, which can also include craftsman devices (such as cordless drills, tools, cases, shelves, etc.). Software components (for example an IoT cloud software, an app, etc.) can also be part of such a system.

Preferably, a token according to an exemplary embodiment of the invention has a mechanical coupling device, which can be configured as an electromechanical coupling. This mechanical coupling device can be plugged onto or into electromechanical couplings of craftsman devices (such as hand-held tools, tools, cases, shelves, etc.). It is also possible to attach a mechanical coupling device of a token to or in a housing provided for this purpose (for example, a tracker) or to or in other devices (for example, a device for filling empty spray cans and the like).

During operation, a token can communicate with the craftsman device or other device into which the token is inserted. In this way, a token can determine on or in which object the token is inserted. A uniform bus is therefore advantageous for all objects. This ensures that in a complex system of a craftsman equipment (for example a machine park or craftsman equipment of a company) each token can be brought into mechanical and communicative connection (in particular control connection) with each craftsman's device. In more general terms, all of the craftsmen's devices in a craftsmen's equipment can be equipped with a mechanically identical mechanical connection device, all of which enable optional coupling with the same token. In other words, the token can be plugged into all these items as a module.

According to an exemplary embodiment, a token can transmit documents and/or control signals to the craftsman device (for example, a cordless drill) into which the token has been inserted. Alternatively or additionally, it is possible for a token to download documents relating to an additional device (e.g. a tool, an adapter, etc.) connected to a hand-held tool. A token can also download documents relating to a workpiece to be processed with a craftsman device (for example a concrete anchor) and thus control the craftsman device accordingly (for example controlling a speed for drilling and/or screwing in a concrete anchor).

Preferably, a token can download authorizations for a craftsman device (e.g. a hand-held tool, tool, case, shelf, etc.) so that the craftsman device can only be operated in a specific spatial area (e.g. drilling machines only on a construction site). For example, a GPS sensor can be implemented in the token or associated craftsman device to provide up-to-date location information.

In particular, a token according to an exemplary embodiment of the invention can download authorizations for a craftsman device (for example, a hand-held tool, tool, case, shelf, etc.) so that the craftsman device can only be used or operated by certain persons (for example, only instructed personnel). In particular, the token can download authorizations for the hand-held tool so that the hand-held tool can only be operated with certain personal protective equipment.

A token can control a mechanically coupled craftsman device, for example switching a vacuum cleaner on or off. For example, when a drill is switched on, the token can also trigger the switching on of a drill dust extractor, so that a user does not need another hand to switch on an associated vacuum cleaner.

According to an embodiment example, a token can be equipped with an optical sensor (for example a camera or a laser scanner) to identify a product or a body (for example a wall or a screw) that is processed with a craftsman device.

It is also possible for the token to download product information about the product from a node of a communication network that is connected to it in a communicable manner. The token or a craftsman device mechanically coupled to it then knows how the product is to be processed, for example what torque is to be applied.

A token according to an exemplary embodiment of the invention can be communicably coupled with at least one other entity (in particular at least one further token, a central control device, a reordering device, a portable user terminal, etc.). This can be done via an associated communication network by enabling communication in accordance with an associated communication protocol. According to exemplary embodiments of the invention, a WLAN (Wireless Local Area Network) communication network, a LAN (Local Area Network) communication network, a PAN (Personal Area Network) communication network, an LPWAN (Low Power Wide Area Network) communication network and/or a SIM (Subscriber Identity Module) communication network (in particular eSIM, nuSIM or nanoSIM) can be used as possible communication networks.

Preferably, a token has a wireless connection to a communication network (in particular the public Internet and/or an intranet). For this purpose, a token can, for example, be equipped with a WLAN antenna (for example with a range of up to 5 m).

A token according to an exemplary embodiment of the invention can be communicatively coupled to a craftsman device via a wireless or wired connection.

Preferably, such a token is modularly interchangeable and can be inserted into various craftsman devices, for example electrical or motorized hand-held tools (for example cordless drills, rechargeable batteries, adapters), tools, storage systems (such as cases, shelves), etc. For example, a token can have a housing with a tracker.

Preferably, a token according to an exemplary embodiment of the invention may have an electromechanical interface that can be electromechanically connected to a mechanical connection interface of a plurality of craftsman devices that is always the same.

According to one embodiment of the invention, a token can download documents or data records from a communicatively coupled node. For example, control of a craftsman device mechanically coupled to the token can be performed using the downloaded documents or data sets. Alternatively or additionally, according to an exemplary embodiment of the invention, a token can upload documents or data records to a node communicably coupled to the token (for example error messages, status information, sensor data).

A token can advantageously load authorizations in a user system for craftsman devices on a cloud and lock or appropriately control craftsman devices and the like based on this.

In particular, a token according to an exemplary embodiment example can support different technologies in different variants of a token arrangement consisting of tokens with different degrees of functionality, For example, a first-generation token can only support Bluetooth and only have a temperature sensor and a vibration sensor as sensors. A second-generation token can also have NB-IoT functionality and additionally have a gyroscope as a sensor. A GPS sensor, a UWB module and/or a fingerprint sensor can also be included in a second-generation token.

In particular, a token can be connected to an app installed on a user's mobile device, for example to recognize a tool (e.g. a drill) or a workpiece (e.g. a concrete anchor) and to control and process it accordingly.

Advantageously, a token according to an exemplary embodiment example can be in connection with a gateway. Alternatively or additionally, a token can be in communication connection with one or more other tokens.

A token according to an exemplary embodiment of the invention may also provide anti-theft protection for an associated craftsman device. For example, a token for this purpose may be equipped with a user identification sensor (for example, a fingerprint sensor, a face recognition sensor or the like) to identify a legitimate user. Operation of an associated craftsman device can only be authorized with a correspondingly approved token. If a thief or unauthorized user is In possession of a craftsman device including a token, the thief or unauthorized user cannot operate the craftsman device, as this requires identification of an authorized user via the user identification sensor.

For example, indicative information (e.g. an authorization profile) can be stored on a token for a user's authorization. Alternatively or additionally, such authorization information can also be stored elsewhere in a communication network, for example in a cloud.

For example, a token can download an authorization of a user and/or for craftsman devices in relation to a user from a node (in particular a cloud). Such a user profile can then be used by the token to control a craftsman device mechanically coupled to the token in accordance with the user profile. Advantageously, the token can store information regarding a user's authorizations locally after each download so that this information is also available offline. Authorization profiles can alternatively or additionally also be stored in a craftsman device (for example in a processing machine and/or in a battery block).

According to an exemplary embodiment, a token can then identify itself on the processing machine and/or the battery pack or another craftsman device.

Advantageously, authorizations of an authorization profile can also include user-specific data, i.e. be related to at least one personal characteristic of the user. For example, if a hand-held tool is too heavy for a user (e.g. at an advanced age), this hand-held tool can be blocked for this user.

According to an exemplary embodiment of the invention, a token can be inserted into a tracker. Such a tracker then allows the token to be located over a large spatial area. For example, such a tracker can be attached to a machine of the craftsman equipment, for example by gluing, by a magnet or by mechanical latching. The token can, for example, be inserted into such a tracker. In particular, the tracker can have a battery and one or more antennas for RFID and/or WLAN and/or Bluetooth to enable spatial localization of the token via one or more communication protocols.

A token according to an exemplary embodiment of the invention is thus configured or configurable for different types of use: for example, such a token can be personalized to a specific user by permanently assigning the user to the token via a user profile stored on the token or retrievable from the token. Alternatively or additionally, it is possible to couple such a token with a craftsman device in order to be able to quickly locate a craftsman device of a larger craftsman equipment in a spatially distributed arrangement of craftsman devices. Alternatively or additionally, it is also possible to have a token communicate with a central control device so that information can be transmitted unidirectionally or bidirectionally between the token and the central control device. For example, the control device can transmit control information to the token to control the execution of a processing task (e.g. drilling a hole in a concrete wall) by a craftsman device mechanically coupled to the token. It is also possible to upload information from the token to the central control device, for example regarding the current charge status of a battery of the token and/or a mechanically coupled craftsman device or the filling status of a storage system of the craftsman device, for example a shelf.

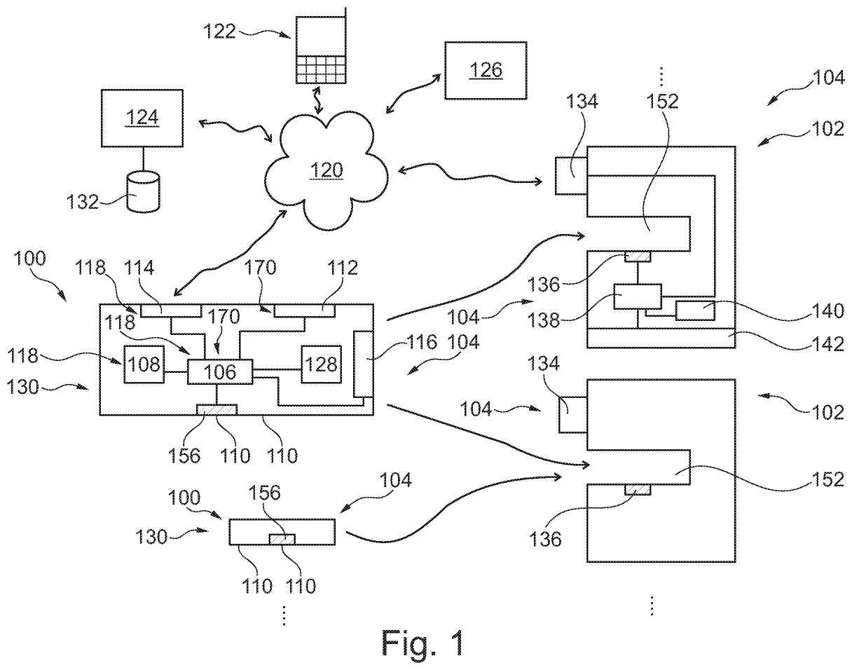

FIG. 1 shows a craftsman equipment 104, for example a workshop equipment or a machine park or craftsman equipment of a company, with craftsman devices 102 and tokens 100 according to an exemplary embodiment of the invention, which are coupled in a communication network 120.

More specifically, the craftsman equipment 104 comprises a plurality of tokens 100, which may, for example, all be shaped and dimensioned in the same way. In FIG. 1, only two such tokens 100 are shown, but a much larger number of tokens 100 is possible in a craftsman equipment 104 (for example at least ten, in particular at least one hundred).

In addition, a plurality of craftsman devices 102 is provided in the craftsman equipment 104. FIG. 1 shows only two such craftsman devices 102, but a much larger number of craftsman devices 102 is possible in a craftsman equipment 104 (for example at least ten, in particular at least one hundred). Some or all of the craftsman devices 102 may include an identically shaped and dimensioned mechanical receiving device 152, here formed as an insertion or receiving aperture configured to mechanically couple with a respective mechanical coupling device 110 of any user-selected one of the tokens 100. A positive connection can be formed between each mechanical coupling device 110 of each token 100 and each mechanical receiving device 152 of each craftsman device 102 by plugging them together.

When a mechanical connection is formed between a token 100 and a selected craftsman device 102 by inserting the mechanical coupling device 110 of the token 100 into the receiving device 152 of the selected craftsman device 102, an active or communication connection is simultaneously formed between the token 100 and the craftsman device 102. More specifically, in the illustrated embodiment example, an electrical connection is formed between one or more electrical contacts 156 on an exterior of each token 100 and one or more electrical mating contacts 136 on an interior of each receiving device 152 of each craftsman device 102. The formation of a positive fit between a respective token 100 and a respective receiving device 152 of a craftsman device 102 thus leads to the formation of an electrical contact and thus an electrically conductive connection between the token 100 and this craftsman device 102. This electrical connection also forms an electrical communication connection between the token 100 and the craftsman device 102, which in particular enables the transmission of electrical signals (for example control signals). As an alternative to this contact-based electrical coupling, a wireless or contactless communication link can be formed between a token 100 and a 102 by inserting the token 100 into the receiving device 152 to bring a transponder (for example, an RFID tag, not shown) of the token 100 within a readability distance of a transponder reader (for example, an RFID reader, not shown) of the craftsman device 102 (not shown).

Advantageously, a token 100, if it has been brought into communication with the handheld tool 102 by insertion into the receiving device 152 of a craftsman device 102, is configured to control this handheld tool 102. Operation of the craftsman device 102 in a state without coupling with the token 100 can be prevented. In other words, the use of the token 100 and the craftsman device 103 can only be enabled once the token 100 and the craftsman device 103 have been successfully coupled.

By allowing each token 100 to be selectively coupled to each mechanical receiving device 152 of a selected craftsman device 102, a flexibly combinable, modular system for operating, controlling and/or managing craftsman devices 102 in a complex craftsman equipment 100 is provided.

In FIG. 1, the craftsman devices 102 are only partially and only schematically shown. For example, a first part of the craftsman devices 102 may be configured as electric or motorized hand-held tools, for example as electric drills, electric cordless screwdrivers, etc. Craftsman devices 102 configured as electric or motorized hand-held tools may, for example, have a functional device 134 which performs the actual function of the respective hand-held tool and can be driven by means of an electric or motorized drive. In the case of a craftsman device 102 configured as a drill, the functional device 134 may, for example, be a drill chuck (in particular with a drill bit). In the case of a craftsman device 102 configured as a cordless screwdriver, the functional device 134 can be, for example, a bit holder (in particular with a bit). Furthermore, a hand-held tool may have a power supply device 142, for example a removable and rechargeable battery pack. Such a power supply device 142 can supply the functional device 134 with electrical drive energy during operation. Alternatively or additionally, the power supply device 142 may also supply a token 100 with electrical power when the token 100 is received in the receiving device 152. A hand-held tool may also include a control device 138, which may be configured to control the hand-held tool (for example, when a hand-held tool is not coupled to a token 100) and/or to interact with a processor 106 of a coupled token 100.

A second part (not shown) of the craftsman devices 102 may be formed as (in particular non-electric or non-motorized) tools or tool sets, for example as a screwdriver, drill or drill box, bit or bit box, etc.

A third part (not shown) of the craftsman device 102 can be configured as storage systems for storing hand-held tools, tools and consumables. Examples of such storage systems are boxes, cases, drawers and/or shelves for holding or storing hand-held tools, tools and/or consumables.

A fourth portion (not shown) of the craftsman devices 102 may be formed as a consumable item, such as boxes of screws or dowels, or as a bolt anchor.

A fifth portion (not shown) of the craftsman devices 102 may be formed as motorized vehicles, for example, cars or trucks, forklifts and/or excavators, such as those used in performing hand tasks. Non-motorized vehicles driven by muscle power, such as a pushable tool trolley, can also be used.

A sixth portion (not shown) of the craftsman tools 102 may be formed as other tools and implements of the craftsman equipment 104, such as ladders, scaffolding, etc.

A portion or each of the described craftsman devices 102 may be temporarily or permanently equipped with a token 100.

Advantageously, the craftsman devices 102 for coupling with the tokens 100 are configured such that a use of a craftsman device 102 coupled with a token 100 can be allowed, set and/or prevented by a user based on a personalized authorization profile. More specifically, a user of a token 100 may be assigned a user profile that may include information with respect to an enablement and authorization of that user to use certain craftsman devices 102, but may also define usage restrictions and/or usage prohibitions with respect to certain craftsman devices 102. Such a user profile may be stored in a memory device 128 of a token 100, in a memory device 140 of a craftsman device 102 and/or in a database 132 of a node (in the Illustrated embodiment example a central control device 124, alternatively another node) communicably coupled to the token 100 via a communication network 120.

The structure of the token 100, which is shown in detail in FIG. 1, is described in more detail below as an example. Said token 100 is used, for example, for user-related control of a selectable one of the craftsman devices 102 of the craftsman equipment 104 and has a processor 106 for this purpose. For example, the processor 106 may be embedded inside the token 100 and thereby protected. The processor 106 may, for example, be in the form of a microprocessor. It is possible to form the processor 106 as part of a processor unit, as an entire processor unit or as a plurality of interacting processor units. The processor 106 of the token 100 is used for control-related interaction with different craftsman devices 102 of the craftsman equipment 104, and in particular interacts functionally with a selected craftsman device 102 into whose receiving device 152 the token 100 is inserted.

Furthermore, the token 100 includes a cryptographic unit 108 that supports cryptographic communication of the token 100. More specifically, the cryptographic unit 108 can be used to encrypt a communication of the token 100 with a communication partner device in the communication network 120, For example, such encrypted communication supported by the cryptographic unit 108 can take place between the token 100 on the one hand and a central control device 124, a user terminal 122 and/or a reordering device 126 on the other hand. Encrypted communication increases data security during communication via the communication network 120. Optionally, it is also possible to use the cryptographic unit 108 to carry out encrypted communication between the token 100 and a craftsman device 102 mechanically coupled to it, for example when transmitting control signals from the token 100 to a craftsman device 102 configured as a hand-held tool. This leads to secure control of a respective craftsman device 102, since a hacker attack or unauthorized control from outside can be prevented as a result.

As already mentioned, the token 100 has the mechanical coupling device 110, which is configured for preferably positive mechanical coupling with a receiving device 152 of a respective one of different craftsman devices 102 of the craftsman equipment 104. The mechanical coupling device 110 of the token 100 is defined by its outer shape, which is shaped inversely to the inner shape of a receiving device 152 of a respective craftsman device 102.

Advantageously, when the mechanical coupling device 110 is mechanically coupled to a receiving device 152 of a selected craftsman device 102, the token 100 may be configured to control the operation of said craftsman device 102 by means of the processor 106 (and optionally the cryptographic unit 108 using cryptographic communication). More specifically, the processor 106 of the token 100 may control the craftsman device 102 and, in particular, its functional device 134 such that the desired processing task is performed by the craftsman device 102 as intended. For example, the processor 106 of the token 100 may specify the torque to be applied by a drill bit of a craftsman device 102 configured as a drill to a substrate in which a borehole is to be drilled.

Advantageously, the token 100 can be configured for user-related control of the craftsman device 102, in particular on the basis of a personalized authorization profile of the user. For this purpose, the token 100 can be provided with an identification device 170, which is configured to identify a user of the token 100. The identification device 170 is formed by a sensor 112, configured for example as a fingerprint sensor, and the part of the processor 106 that identifies the user from sensor data determined by means of the sensor 112, for example by pattern matching with reference data. More precisely, the sensor 112 is designed, for example, as a fingerprint sensor on which a user places a finger for identification. Advantageously, the sensor 112 can therefore be located in a surface area of the token 100. The sensor 112 can then determine whether the data recorded by the sensor 112 indicates that the user is an authorized or authorized user or which user it is. This determination can be made by comparing the sensor-detected data with sensor reference data (for example, a fingerprint of an authorized user stored in a database).

The aforementioned memory device 128 of the token 100 may store information indicative of, or providing access to, a personalized authorization profile of the user with respect to the craftsman device 102. More specifically, the memory device 128 of the token 100 may store a set of data representing or mapping an authorization profile of a user (or multiple authorization profiles of multiple users). However, it is also possible that the authorization profile of one or more users is stored in an entity remotely located with respect to the token 100, for example in a central database 132 of a central control device 124, through which the token 100 may be communicably coupled by means of the communication network 120. To access an authorization profile of a user, it may then be sufficient to store access information (for example, a link to the central database 132, possibly in combination with a password) in the token 100 to access the remotely stored authorization profile.

The processor 106 may be configured to control the operation of the craftsman device 102 coupled to the token 100 in accordance with the user authorization profile of the user of the token 100. In particular, the processor 106 may be configured to enable the operation of the craftsman device 102 coupled to the token 100 only if a user identification performed in advance by means of the token 100 has led to the result that an identifying user is authorized to operate the craftsman device 102. Advantageously, the processor 106 of the token 100 can thus be configured to allow, set and/or prevent use of the craftsman device 102 by the user based on the personalized authorization profile when coupled to the craftsman device 102. For example, a processing task desired by a user using a craftsman device 102 may only be permitted for certain users, for example if the user has received specific instruction or has received a special qualification (for example a driver's license) to use the craftsman device 102. If the authorization profile of the user does not meet such a condition, the use of the craftsman device 102 can be prevented by the processor 106 of the token 100. However, if the authorization profile of the user meets such a condition, the use of the craftsman device 102 can be permitted by the processor 106 of the token 100. If certain processing tasks are only permitted to a limited extent for a user due to an authorization profile, the use of the craftsman device 102 by the user is only permitted if an associated condition is met. For example, the use of a craftsman device 102 by a user may only be authorized if the user is wearing protective equipment (for example, safety goggles). If such protective equipment is also visible with a token 100, the processor 106 can search for a communicably coupled token 100 indicating protective equipment and only allow the desired processing task by a user when the presence of protective equipment has been detected by the presence of such a token 100.

As shown in FIG. 1, the craftsman equipment 104 may include a token arrangement 130 comprising a plurality of tokens 100, wherein different ones of the tokens 100 have different degrees of functionality. For example, the tokens 100 of a craftsman equipment 104 may be divided into tokens 100 of a first, second, and third generation. Each token 100 of any generation may thereby fulfill the basic function of a token 100, as described above. Tokens 100 of higher generations may furthermore have additional functions and/or additional convenience, but also support the basic function of a token 100 of the lowest generation. Tokens 100 of all generations may have the same form and may be used for use with any of the craftsman devices 102 of the craftsman equipment 104. In other words, the token arrangement 130 is compatible with respect to different generations of tokens 100. The craftsman devices 102 require no adaptation with respect to their interaction with a token 100 of a respective generation, except that a receiving device 152 is provided for mechanically receiving an associated token 100.

Each of the inserted tokens 100 can, for example, be configured as a plug-in element for insertion into a receiving opening of a craftsman device 102. For example, each token 100 may be formed as a circular disk having a diameter in a range of 2 cm to 4 cm and therefore may be conveniently handled by a user and inserted into a craftsman device 102 to save space. Other shapes of a token 100 are possible, see for example FIG. 3. Furthermore, the mechanical coupling device 110 of each token 100 is configured to detachably couple the token 100 to the craftsman device 102. Thus, a user can use a token 100 (assigned to him, for example) successively in combination with different craftsman devices 102, wherein the selection of an addressed craftsman device 102 can be made by merely mechanically inserting the mechanical coupling device 110 of the token 100 into an associated receiving device 152 of a target craftsman device 102. Thus, the mechanical coupling device 110 of a token 100 serves as a universal electromechanical interface for different craftsman devices 102.

As already mentioned, the token 100 may comprise one or more sensors 112, including the user identification sensor described above. It is alternatively or additionally possible to equip the token 100 with, for example, a gyro sensor, a location sensor and/or a temperature sensor. A gyro sensor can detect, for example, when a craftsman device 102 with a token 100 accommodated therein falls down and is consequently subjected to a shock. In this case, the craftsman device 102 can be switched off as a precaution to prevent injury to a user and damage. A location sensor (for example a GPS sensor) of the token 100 allows the current position of the token 100 together with the craftsman device 102 to be detected. The use of a craftsman device 102 can be restricted (for example in a user profile) to a specific room area (for example a specific construction site), for example to prevent misuse. If a location sensor detects that a craftsman device 102 together with the token 100 is located in a location not authorized for use, the processor 106 of the token 100 can switch off or deactivate the craftsman device 102 to prevent misuse. A temperature sensor of the token 100 can detect the ambient temperature. If a processing task (for example, setting a chemical dowel) is only permitted under certain temperature conditions, operation of the craftsman device 102 can be made impossible for safety reasons if a temperature condition is not met in view of the temperature sensor data detected.

Optionally, the token 100 has a power supply device 116, for example a replaceable battery or a rechargeable battery. The token 100 can then be operated autonomously. Alternatively or additionally, the token 100 can be supplied with electrical energy by a power supply device 142 of a craftsman device 102 when the token 100 is received in the receiving device 152.

FIG. 1 further shows that the token 100 can have a communication antenna 114, for example a WLAN antenna. It is also possible and advantageous for reasons of diversity if the token 100 has several communication antennas 114 which, for example, support different communication protocols. For example, a communication antenna 114 may be realized in the form of a planar coil, which is preferably arranged in a surface area of the token 100. A communication antenna 114 may be formed as a transmit/receive antenna. It is also possible to provide a transmitting antenna and a separate receiving antenna, or only one of these antennas.

In addition, the token 100 shown in FIG. 1 has a communication device 118, which can be formed by interaction of the communication antenna 114 with a corresponding part of the processor 106 and optionally with the cryptographic unit 108. The communication device 118 is used for communicating the token 100 with one or more communication nodes via the communication network 120, which may be, for example, the public Internet, an intranet or a mobile network.

For example, the token 100 may communicate via the communication network 120—or directly—with another token 100 of the workman equipment 104. This may be done, for example, for the purpose of recognizing the presence of protective equipment equipped with a token 100 (which may be made a condition for enabling the use of a craftsman device 102 for work safety reasons).

Alternatively or additionally, it is possible to form a communicable coupling between the token 100 and an app or other software stored on a portable user terminal 122 via the communication network 120. In the illustrated embodiment example, the user terminal 122 is a mobile device with a user interface with which a user can control and/or monitor the communicably coupled token 100 and/or a craftsman device 102 coupled thereto. By means of the user terminal 122, a user can control and/or monitor the craftsman equipment 104 even from a remote position. For example, a token 100 can connect via an app to the user terminal 122 configured here as a mobile radio device. By means of the user terminal 122, data can be downloaded to the token 100, for example a user profile of a user of the user terminal 122. Furthermore, it is possible for the token 100 to access resources of the user terminal 122 during operation, for example a processor contained therein and/or a camera of the user terminal 122.

For example, a camera included in the user terminal 122 may be used to capture an image of a product package that provides an inference of a consumable used for a machining task (for example, a type of screw). This information can be communicated from the user terminal 122 to the token 100 so that control of a craftsman device 102, for example, configured as a cordless screwdriver, to set a corresponding screw can be performed accordingly by the token 100. In more general terms, for example, an optical detection device, in particular a camera, can be provided on the token 100 and/or on the user terminal 122, which is configured to detect processing information indicative of a processing task to be carried out by means of the craftsman device 102. Advantageously, the processor 106 may be configured to perform the processing task using the detected processing information.

Alternatively or additionally, it is possible to form a communicable coupling between the token 100 and a central control device 124 (for example, for controlling a plurality of craftsman devices 102) via the communication network 120. The central control device 124 may be provided with an access right to a database 132, from which data records can be transmitted to the token 100.

Such data records may include, for example, a user profile requested by the token 100, an operational data record for performing a processing task with a craftsman device 102 mechanically coupled to the token 100, etc. Thus, the token 100 can be configured to download a data set by means of the communication device 118 from the central control device 124 or another node of the communication network 120 that is coupled in a communicable manner, in particular a data set defining an operating sequence of the craftsman device 102 and/or a data set defining a user profile of a user of the token 100.

Furthermore, the communicable coupling between the token 100 and the central control device 124 makes it possible to transmit data from the token 100 to the control device 124 for storage in the database 132. Such data may be, for example, tracking data that allows tracking of a craftsman device 102 coupled to a respective token 100. Thus, the token 100 can be configured to upload a data set by means of the communication device 118 to the control device 124 or another node of the communication network 120 that is coupled in a communicable manner, in particular a data set containing operating results and/or operating parameters of an operation of the craftsman device 102.

Finally, it is possible that the token 100 is coupled via the communication network 120 to a reordering device 126 for reordering consumables for operating a craftsman device 102. If a token 100 detects (for example by means of a token's own, for example optical, sensor 112 and/or by means of a camera Image of the user terminal 122) that a remaining stock of a certain consumable (for example a certain type of screw for setting into a substrate by means of a craftsman device 102 configured as a cordless screwdriver into which the token 100 is inserted) has fallen below a critical threshold value, the token 100 can inform the reordering device 126 accordingly via the communication network 120 and thereby trigger or initiate a reordering of this consumable. The reordering device 126 can be a computer, which in turn can be coupled to supplier nodes via the communication network 120 in order to carry out the reordering. A reordering of consumables can thus be triggered by a token 100, for example if it has been detected by means of the token 100 and/or a craftsman device 102, for example by sensors, that a remaining stock of certain consumables has fallen below a predetermined threshold value.

During operation of the craftsman equipment 100, a user of the token 100 can first be identified by means of the sensor 112, which is configured as a fingerprint sensor, for user-related control of a craftsman device 102 by means of a token 100. Then, a mechanical coupling of the mechanical coupling device 110 of the token 100 with the mechanical connection device 152 of the selected craftsman device 102 may be performed. Before or after the mechanical coupling, a personalized authorization profile of the user of the token 100 can be found, for example in one of the memory devices 128, 140. After the mechanical coupling has taken place, the craftsman device 102 can be controlled by means of the processor 106. Advantageously, use of the craftsman device 102 by the user can be permitted, prevented and/or set based on the personalized authorization profile. In particular, the processor 106 can be configured to enable operation of the craftsman device 102 coupled with the token 100 only if a user identification carried out in advance by means of the token 100 has led to the result that an identifying user is authorized to operate the craftsman device 102. Here, the personalized authorization profile may comprise at least one piece of Information from a group consisting of a prohibition of use for at least one defined operating mode of the craftsman device 102 based on a user qualification and/or on a physical (for example, a physical limitation) or biological (for example, an advanced age) user characteristic, a user-specific permission of use for at least one defined operating mode of the craftsman device 102, and a condition of use for the use of the craftsman device 102, for example, related to occupational safety. For example, the authorization profile for a specific user may include the information that the user is only capable of using craftsman devices 102 up to a certain weight (for example up to 20 kg) due to his physical constitution (for example due to his age, his height and/or his weight).

Furthermore, in such an authorization profile for a particular user, it may be stored for which craftsman devices 102 the user is authorized to operate (for example, a user may only be allowed to use a forklift if the user has a forklift driver's license). Furthermore, it can be stored in a user profile for a specific user and/or for a specific craftsman device 102 which occupational protective work equipment (e.g. protective overalls, ear muffs, safety goggles) must be worn by a user in order to be allowed to use a specific craftsman device 102. A user can be denied the use of a craftsman device 102 by the token 100 until the protective work equipment on this user has been recognized (for example by sensors). For example, the protective work equipment can also be equipped with a corresponding token 100, so that the presence of protective work equipment on the user can be verified by token-token communication.

The processor 106 may be configured to allow or disallow a download of a data set (for example, a data sheet), in particular a data set defining an operation of the craftsman device 102, from a communication network 120 when coupled to the craftsman device 102 based on the personalized authorization profile. For example, an optical sensor (in particular, a camera) of the token 100 and/or on a craftsman device 102 may scan a product package of screws to be set in a substrate (for example, a vertical concrete wall) in an operational mode of the craftsman device 102. In this way, for example, it can be detected by sensors that the screws are M8 screws. The token 100 can then perform or initiate a download of a product specification (as a data set defining an operating sequence) corresponding to the sensor-detected product package. Based on the downloaded data set, the processing task can then be executed without errors, namely by controlling the craftsman device 102 by the token 100 using the downloaded data set.

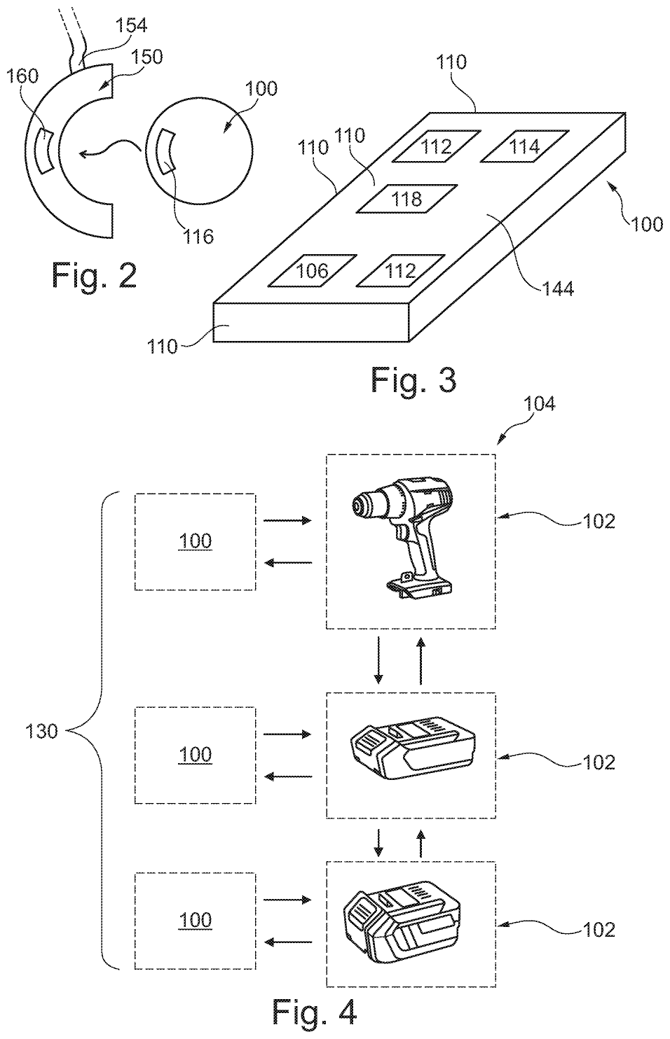

FIG. 2 shows a token 100 with an associated storage and recharging device according to an exemplary embodiment of the invention.

More precisely, the token arrangement shown in FIG. 2 has the token 100 and a token holder 150, which can be configured to hold the token 100 in a form-fit and/or force-fit manner. For this purpose, the token 100 can be clamped in a receiving space of the token holder 150, which is defined between opposing elastic legs of the token holder 150. In this way, a user can store the token 100 in a mechanically protected manner, for example using a connecting element 154. By means of the connecting element 154, a user can carry the token holder 150, optionally together with the token 100 held therein, in a fixed manner, for example by attaching it to a belt loop.

It is also possible to attach a token 100 with a completely or partially discharged energy supply device 116 (for example a rechargeable battery) to the token holder 150 and thereby trigger a recharging of the energy supply device 116. For this purpose, electrical energy can be transferred (for example by an electrical contact or in an inductive manner) from a charging device 160 of the token holder 150 to the energy supply device 116 of the token 100.

FIG. 3 shows a token 100 according to an exemplary embodiment of the invention. The token 100 according to FIG. 3 is formed as a rectangular strip that can be Intuitively inserted into an inversely shaped recess in the Interior of a craftsman device 102.

FIG. 4 shows components of a craftsman equipment 104 according to another exemplary embodiment of the invention.

The craftsman equipment 104 according to FIG. 4 includes, for example, three craftsman devices 102 and, for example, three tokens 100.

The three craftsman devices 102 shown in FIG. 4 are configured as a drill (top), sensor module (middle) and battery block (bottom) and can be connected to each other. During operation, the battery block supplies the drilling machine with electrical energy, while the sensor module detects operating data of the drilling machine by sensors (and uses these, for example, as a basis for a control system). Bidirectional signal coupling (i.e. in the direction of transmission and in the direction of reception) is possible between the drilling machine and the sensor module, see the two arrows. Similarly, bidirectional signal coupling is possible between the sensor module and the battery block.

Bidirectional signal coupling is also possible between each of the craftsman devices 102 and a respective one of the tokens 100. The configuration according to FIG. 4 shows that all components 102, 100 can communicate with each other on an equal footing. The communication Interfaces between the components 102, 100 can, for example, be designed in accordance with a UART (Universal Asynchronous Receiver Transmitter) protocol.

The illustrated tokens 100 may form a token array 130 of tokens 100 of varying degrees of functionality, wherein any of the tokens 100 of the token array 130 may be mechanically and functionally coupled to any of the craftsman devices 102.

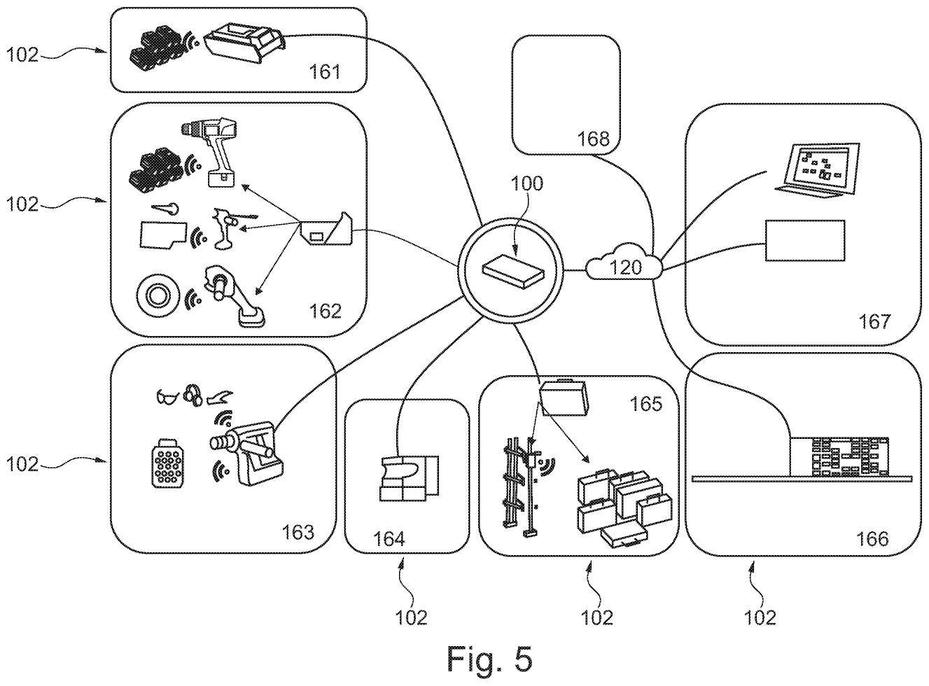

FIG. 5 shows a craftsman equipment 104 with craftsman devices 102 and a token 100 according to an exemplary embodiment of the invention, which are coupled in a communication network 120. FIG. 5 shows a modular craftsman equipment 104 in an Internet of Things (IoT) architecture.

Reference mark 161 shows adapters, reference mark 162 shows hand-held tools, reference mark 163 shows personal protective equipment and wearables, reference mark 164 shows applications of a third party craftsman equipment 164, reference mark 165 shows tracker elements, reference mark 166 shows stocking systems, reference mark 167 shows an inventory management system, and reference mark 168 shows an online store. All of these systems may be included in the token-controlled craftsman equipment 104.

Another application example of a token according to an exemplary embodiment of the invention is described below. At a predetermined time (for example, at a predetermined time of day, such as at the end of the working day), the token can transmit operating data to a target device or to a storage device (for example, to a cloud, an app stored on a portable user terminal, etc.). Such operating data may, for example, contain information regarding an identified user of the token and/or a craftsman device coupled with it. Furthermore, such operating data may contain the information that certain work steps have been carried out with said craftsman device on a certain day (in particular with the addition of additional information such as torque, speed and/or time).

According to another application example of another exemplary embodiment of the invention, communication can be carried out—in particular by means of a token—between a plurality of devices, in particular between a plurality of craftsman devices. For example, communication can be carried out between a first craftsman device (for example a master device) and a second craftsman device (for example a slave device). For example, a first craftsman device (for example, a drill) may turn on a second craftsman device (for example, a vacuum cleaner) when performing a drilling task. In another example, a core drill can communicate with a guide rail for guiding the core drill, for example to transmit current location information. It is also possible for a robot to communicate with an external device, for example to synchronize or ensure that the robot has positioned itself correctly In the room.

According to an exemplary embodiment of the invention, it is also possible to implement a token as a tracker in a craftsman device (for example in a power tool, a battery housing, etc.). This makes it possible to determine the location of the craftsman device. Optionally, at least one sensor or at least one further sensor can also be integrated into the token, for example a temperature sensor and/or a humidity sensor.

In addition, it should be noted that “comprising” does not exclude other elements or steps and “one” or “a” does not exclude a plurality. Furthermore, it should be noted that features or steps described with reference to one of the above embodiments may also be used in combination with other features or steps of other embodiments described above. Reference signs in the claims are not to be regarded as a limitation.

1. A token for craftsman devices of a craftsman equipment, the token comprising:
a processor which is configured for control-related interaction with different craftsman devices of the craftsman equipment;
a cryptographic unit configured to cryptographically communicate the token; and
a mechanical coupling device which is configured for mechanical coupling with different craftsman devices of the craftsman equipment;
wherein the token is configured to exchange data with said craftsman device by means of the processor when the mechanical coupling device is mechanically coupled to a craftsman device, and in particular to control said craftsman device.

2. The token according to claim 1, wherein the token is configured as a plug-in element for insertion into a receiving opening of a craftsman device.

3. The token according to claim 1, comprising one of the following features:
wherein the token is formed as a disk, in particular as a circular disk, with a diameter in a range from 1 cm to 10 cm, in particular in a range from 2 cm to 5 cm;
wherein the token is configured as a cuboid with an edge length in a range from 1 cm to 10 cm, in particular in a range from 2 cm to 5 cm.

4. The token according to claim 1, wherein the mechanical coupling device is configured to couple the token detachably from the craftsman device.

5. The token according to claim 1, wherein the mechanical coupling device comprises an electromechanical interface, in particular an electromechanical interface universal for different craftsman devices.

6. The token according to claim 1, comprising at least one of the following features:
wherein the token is configured to form a communication link, in particular a contactless or contact-based communication link, with the craftsman device when the mechanical coupling device is mechanically coupled to a craftsman device;
wherein the token comprises at least one sensor, in particular selected from a group consisting of a user identification sensor, a gyro sensor, a location sensor, a temperature sensor, a sound pressure sensor, a vibration sensor, an acceleration sensor, a position sensor, a current sensor, a voltage sensor, and a sensor for measuring an electric and/or magnetic field;
wherein the token comprises at least one communication antenna, in particular selected from a group consisting of a GPS antenna, a BLE antenna, an ultra-wideband antenna, a Bluetooth antenna, a WLAN antenna, and a narrowband Internet of Things antenna;
wherein the processor is selected from a group consisting of a Bluetooth processor, a Narrowband Internet of Things processor, an LTE processor, a 5G processor and an NFC processor;
wherein the token comprises a power supply device.

7. The token according to claim 1, wherein the token comprises a communication device configured to communicate by means of a communication network, in particular to communicate cryptographically using the cryptographic unit.

8. The token according to claim 7, comprising at least one of the following features:
wherein the token is configured to communicate by means of the communication device with at least one communicatively coupled node of the communication network, which is selected from a group consisting of another token, a portable user terminal with an app stored thereon, a central control device, and a reordering device for reordering consumables for operating a craftsman device;
wherein the token is configured to download a data record by means of the communication device from a node of the communication network which is coupled in a communicable manner, in particular a data record defining an operating sequence of the craftsman device and/or a data record defining a user profile, in particular an authorization profile, of a user of the token;
wherein the token is configured to upload a data record by means of the communication device to a node of the communication network which is coupled in a communicable manner, in particular a data record indicating operating results and/or operating parameters of an operation of the craftsman device.

9. The token according to claim 1, wherein the processor is configured to control the operation of the craftsman device coupled to the token in accordance with a user profile, in particular in accordance with a user authorization profile, of the user of the token.

10. The token according to claim 9, comprising at least one of the following features:
comprising a memory device in which the user profile, in particular the user authorization profile, is stored;
wherein the processor is configured to enable operation of the craftsman device coupled to the token only if a user identification carried out in advance by means of the token has led to the result that an identifying user is authorized to operate the craftsman device.

11. A token arrangement comprising a plurality of tokens according to claim 1, wherein different ones of the tokens have different degrees of functionality.

12. The token arrangement according to claim 11, comprising at least one of the following features:
wherein tokens of different degrees of functionality have sensors of different degrees of functionality;
wherein tokens of different degrees of functionality have processors of different degrees of functionality;
wherein tokens of different degrees of functionality have communication antennas of different degrees of functionality.

13. A craftsman equipment, comprising:
a token according to claim 1; and
a plurality of craftsman devices, at least some of which comprise a mechanical receiving device for mechanically coupling with the mechanical coupling means of the token;
wherein the token is configured for user-related data exchange with, in particular control of, that one of the craftsman devices to whose mechanical receiving device the mechanical coupling device of the token is mechanically coupled.

14. The craftsman equipment according to claim 13, comprising at least one of the following features:
wherein the craftsman devices comprise at least two different elements from a group consisting of an electrical hand-held tool, a tool or a tool set, a storage system, a consumable, and a vehicle;
wherein at least one of the craftsman devices is configured as an electric hand-held tool, in particular from a group consisting of a drill, a cordless screwdriver, a cordless drill driver, a rotary screwdriver, a pulse screwdriver, a ratchet screwdriver, an impact driver, in particular a cordless impact driver, a hammer drill, a corded hand-held tool and a compressed air-driven hand-held tool.

15. A method of operating craftsman devices of a craftsman equipment by means of a token according to claim 1, wherein the method comprises:
mechanically coupling the mechanical coupling means of the token to a mechanical receiving device of a selected one of the craftsman devices; and
after mechanical coupling has taken place, exchanging data with said craftsman device, and in particular controlling the craftsman device, by means of the processor.
